(19) United States
(12) Patent Application Publication
(10) Pub. No.: US 2026/0158382 A1
(43) Pub. Date: Jun. 11, 2026

(54) MESSAGE PROCESSING METHOD AND APPARATUS, STORAGE MEDIUM, AND ELECTRONIC DEVICE

(71) Applicant: Tencent Technology (Shenzhen) Company Limited, Shenzhen (CN)

(72) Inventors: Ziyi Wang, Shenzhen (CN); Chenghao Ye, Shenzhen (CN)

(21) Appl. No.: 19/181,833

(22) Filed: Apr. 17, 2025

Related U.S. Application Data
(63) Continuation of application No. PCT/CN2024/088830, filed on Apr. 19, 2024.

(30) Foreign Application Priority Data
Apr. 24, 2023 (CN) 202310475236.X

(51) Int. Cl. A63F 13/52

(52) U.S. Cl. CPC A63F 13/52

(57) ABSTRACT

This application discloses a message processing method and apparatus, a storage medium, and an electronic device. The method comprises obtaining, in response to a first trigger operation when a first virtual object is in a state, a message associated with the state. The state indicates a first behavior of the first virtual object in a virtual scene. The method further comprises displaying, on an interaction interface, a shortcut message list including the message; and transmitting the message in response to a second trigger operation on the message.

### CROSS-REFERENCE TO RELATED APPLICATIONS

This application is a continuation application of PCT Application PCT/CN2024/088830, filed Apr. 19, 2024, which claims priority to Chinese Patent Application No. 202310475236.X, filed on Apr. 24, 2023, each entitled “MESSAGE PROCESSING METHOD AND APPARATUS, STORAGE MEDIUM, AND ELECTRONIC DEVICE”, and each of which is incorporated herein by reference in its entirety.

### FIELD OF THE TECHNOLOGY

This application relates to the field of computer technologies, and in particular, to a message processing method and apparatus, a storage medium, and an electronic device.

### BACKGROUND OF THE DISCLOSURE

In a game scenario, to implement communication between players without typing a character or using a microphone, a player usually transmits a shortcut message to a team of a current game at a key node of the game. Messages selected by the player are uniformly displayed in a shortcut message list on a game interface, and a shortcut message required by the player is determined through a touch operation (for example, sliding).

In a related technology, a quantity and content of messages in the shortcut message list are fixed. For example, in any scenario, 10 messages are displayed, and content and an order of each message are fixed. However, requirements of a player for a shortcut message are different in different states. In this case, the player needs to find a shortcut message most suitable for a current case through a slide operation. In addition, because a quantity of messages in the shortcut message list is limited, a shortcut message currently needed by the player may not be found through a continuous slide operation.

In the foregoing shortcut message processing process, the player needs to perform a plurality of operations to find a shortcut message meeting a requirement, and in a case that the shortcut message meeting the requirement is not found, complexity of processing the shortcut message is further increased, operations of the player are added, and a large amount of operation time is consumed, causing a technical problem of relatively low efficiency in a message processing process. In view of the foregoing problem, no effective solution has yet been proposed.

### SUMMARY

This application provides a message processing method and apparatus, a storage medium, and an electronic device, to resolve at least a technical problem of relatively low efficiency that occurs in a message processing process.

According to an aspect of the examples of this application, a message processing method is provided, performed in an electronic device, the method comprising: obtaining, in response to a first trigger operation when a first virtual object is in a state, a message associated with the first state, the state indicating a first behavior of the first virtual object in a virtual scene; displaying, on an interaction interface, a shortcut message list including the message; and transmitting the message in response to a second trigger operation on the message.

According to another aspect of the examples of this application, a message processing apparatus is further provided, including:

an obtaining unit, configured to obtain, in response to a first trigger operation in case that a first virtual object is in a state, a message associated with the current first state of the first virtual object, the state indicating a first behavior of the first virtual object in a virtual scene; a display unit, configured to display, on an interaction interface, a shortcut message list including the message; and a transmitting unit, configured to transmit the message in response to a second trigger operation on the message.

According to still another aspect of the examples of this application, a non-transitory computer-readable storage medium is further provided, the computer-readable storage medium having a computer program stored therein, and the computer program being configured to perform the foregoing method when being run.

According to still another aspect of the examples of this application, a computer program product is further provided, including a computer program/instructions, the computer program/instructions, when being executed by a processor, implementing the foregoing method.

According to still another aspect of the examples of this application, an electronic device is further provided, including a memory and a processor, the memory storing a computer program, and the processor being configured to perform the foregoing method by using the computer program.

### BRIEF DESCRIPTION OF THE DRAWINGS

The accompanying drawings described herein are configured for providing a further understanding of this application and constitute a part of this application. Examples of this application and descriptions thereof are provided for explaining this application and do not constitute an improper limitation to this application.

FIG. 1 is an exemplary schematic diagram of an application scenario of a message processing method according to an example of this application.

FIG. 2 is an exemplary flowchart (I) of a message processing method according to an example of this application.

FIG. 3 is an exemplary schematic diagram (I) of displaying a first message according to an example of this application.

FIG. 4 is an exemplary schematic diagram of a first message according to an example of this application.

FIG. 5 is another exemplary schematic diagram of a first message according to an example of this application.

FIG. 6 is an exemplary schematic diagram of displaying a first message on a game interface according to an example of this application.

FIG. 7 is an exemplary flowchart (II) of a message processing method according to an example of this application.

FIG. 8 is an exemplary schematic diagram of performing a long-press operation on a first message according to an example of this application.

FIG. 9 is an exemplary flowchart (III) of a message processing method according to an example of this application.

FIG. 10 is an exemplary schematic diagram of performing a first operation in a target game application according to an example of this application.

FIG. 11 is an exemplary schematic diagram of performing area division on an electronic map according to an example of this application.

FIG. 12 is an exemplary flowchart (IV) of a message processing method according to an example of this application.

FIG. 13 is an exemplary schematic diagram (II) of displaying a first message according to an example of this application.

FIG. 14 is an exemplary schematic diagram (III) of displaying a first message according to an example of this application.

FIG. 15 is an exemplary schematic structural diagram of a message processing apparatus according to an example of this application.

FIG. 16 is an exemplary schematic structural diagram of an electronic device according to an example of this application.

### DESCRIPTION OF EMBODIMENTS

To make a person skilled in the art better understand the solutions of this application, the following clearly and completely describes the technical solutions in this application with reference to the accompanying drawings in the application. Apparently, the described examples are merely some but not all of the examples of this application. All other examples obtained by a person of ordinary skill in the art based on the examples of this application without creative efforts shall fall within the protection scope of this application.

In the specification, claims, and accompanying drawings of this application, the terms such as “first” and “second” are intended to distinguish between similar objects rather than indicating a specific order or sequence. Data used in this way can be interchanged in an appropriate case, so that the application that are described herein can be implemented in an order other than the order illustrated or described herein. In addition, the terms “include”, “have”, and any other variations thereof mean to cover a non-exclusive inclusion, for example, a process, method, system, product, or device that includes a series of steps or units is not necessarily limited to those clearly listed steps or units, but may include other steps or units not clearly listed or inherent to such a process, method, product, or device.

During implementation of the technical solutions in this application, legal stipulations may be complied with. When an operation is performed according to the technical solutions described herein, used data does not relate to user privacy, and the security of the data is ensured when it is ensured that the operation process is compliant and valid.

A shortcut phrase is also referred to as a shortcut message. A shortcut message is, for example, a short message that is selected and transmitted on an interaction interface. For example, in a virtual scene such as a video game, a message button on the interaction interface can be tapped/clicked, and a shortcut phrase list including N phrases is displayed on the interaction interface. After a corresponding phrase is tapped/clicked, the selected phrase is transmitted to, for example, a receiver, and the shortcut phrase list is closed.

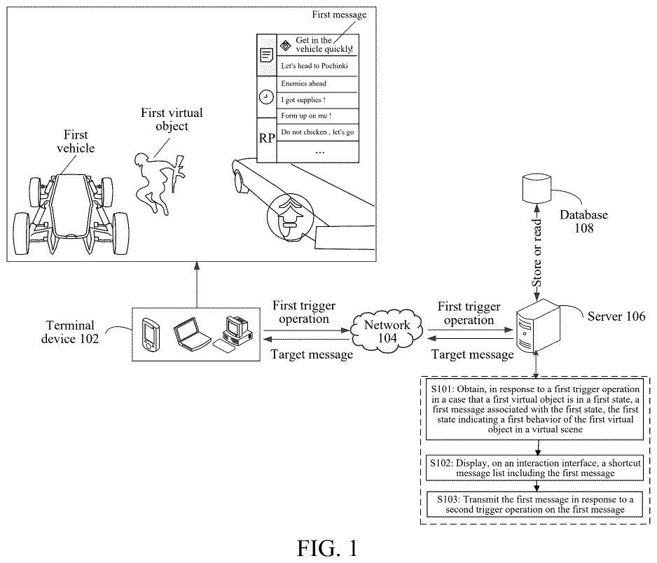

According to an aspect of the examples of this application, a message processing method is provided. In an exemplary implementation, the message processing method may be applied to, but is not limited to, an application scenario shown in FIG. 1. In the application scenario shown in FIG. 1, a terminal device 102 may, but is not limited to, communicate with a server 106 through a network 104, and the server 106 may, but is not limited to, perform an operation such as a data writing operation or a data reading operation on a database 108. The terminal device 102 may include, but is not limited to, a human-machine interaction screen, a processor, and a memory. The human-machine interaction screen may be configured to, but is not limited to, display a game interface on the terminal device 102, a shortcut message list, a first message, and the like. The processor may be configured to, but is not limited to, perform a corresponding operation in response to the human-machine interaction operation, or generate a corresponding instruction and transmit the generated instruction to the server 106. The memory is configured to store related processing data, for example, a first trigger operation, the shortcut message list, and a login account.

For example, the following operations of the message processing method may be performed on the server 106: Operation S101: Obtain, in response to a first trigger operation in a case that (e.g., if) a first virtual object is in a first state, a first message associated with the first state, the first state indicating a first behavior of the first virtual object in a virtual scene. Operation S102: Display, on an interaction interface, a shortcut message list including the first message. Operation S103: Transmit the first message in response to a second trigger operation on the first message.

In the foregoing manner, if the virtual object is in the first state, the first message corresponding to the first state may be displayed, through the first trigger operation, in the shortcut message list on the interaction interface (for example, a game interface), and the first message may be transmitted through the second trigger operation. The transmitted first message is, for example, displayed on the interaction interface. In other words, a target message (for example, the first message) meeting a scenario requirement can be quickly transmitted to a message receiver through a simple touch operation, and a user does not need to edit a message or select a message through a slide operation, to reduce a large quantity of operation processes, and achieve a technical effect of improving message processing efficiency.

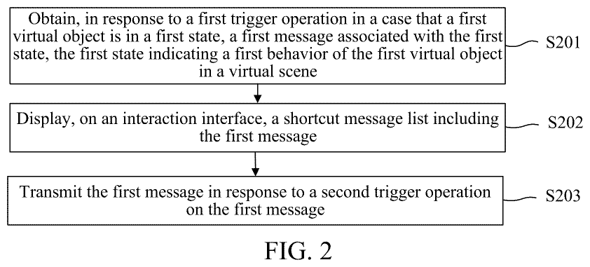

An example of this application provides a message processing method. FIG. 2 is a flowchart of a message processing method according to an example of this application. The process includes the following operations.
S201: Obtain, in response to a first trigger operation in a case that a first virtual object is in a first state, a first message associated with the first state, the first state indicating a first behavior of the first virtual object in a virtual scene.
S202: Display, on an interaction interface, a shortcut message list including the first message.
S203: Transmit the first message in response to a second trigger operation on the first message.

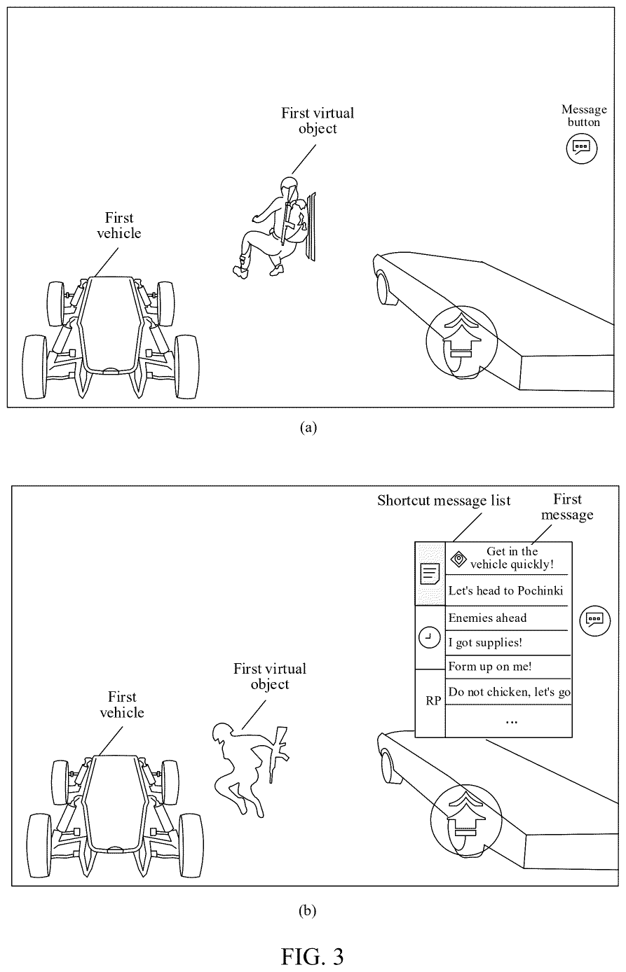

If the first virtual object is switched from a squatting state to a jumping state shown in (b) in FIG. 3, a message button can be tapped/clicked (namely, the first trigger operation), and the first message associated with the first state is obtained; and then the shortcut message list is displayed on the interaction interface (for example, a game interface), and two first messages “Get in the vehicle quickly” and “Let's head to Pochinki” corresponding to the jumping state are displayed in the shortcut message list.

The jumping state is merely an example of the first state, and is not limited thereto. For example, the first state may alternatively be a falling-to-ground state, a shooting state, a running state, a parachuting state, or a fighting state. In other words, the first behavior may be set according to a scenario. For example, the first behavior is jumping, falling to ground, shooting, running, parachuting, or fighting.

For example, when the first virtual object is in the falling-to-ground state, the message button is tapped/clicked, and the first message “Come to save me” may be displayed in the shortcut message list. When the first virtual object is shooting, the first message “Come here. I need backup” is displayed in the shortcut message list.

In some examples, it is stipulated, through preset execution logic, that when a condition is met (e.g., when the first virtual object is in a specific first state), an associated first message is displayed, to avoid trouble of editing a message or finding a message through a slide operation by a user, and facilitate the user to transmit an expected message, so as to improve message transmitting efficiency and operation convenience. According to the foregoing examples provided in this application, if the first virtual object is in the first state, the first message corresponding to the first state may be displayed in the shortcut message list on the interaction interface through the first trigger operation, and the corresponding first message may be transmitted through the second trigger operation. In other words, the first message meeting a scenario requirement (e.g., associated with the first state) may be displayed on the interaction interface through a simple touch operation, to avoid trouble of editing a message or finding a message through a slide operation by a user, and facilitate the user to transmit an expected message, so as to improve message transmitting efficiency and operation convenience. For example, in a game scenario, the foregoing solution not only meets communication requirements of players in different game scenarios, but also reduces a large number of operation processes, and achieves a technical effect of improving message processing efficiency.

In some examples, the first virtual object is a virtual character associated with a first account configured for logging in to the virtual scene.

The transmitting the first message in response to a second trigger operation on the first message includes: transmitting, in response to the second trigger operation on the first message, the first message to a second account of one or more second virtual objects associated with the first virtual object. Herein, the second virtual object associated with the first virtual object is, for example, another virtual object that is in the same group as the first virtual object. For example, in a game scenario, virtual objects in the same group are virtual objects located in the same camp.

In some examples, the first message is associated with a first operation; and the message processing method further includes: displaying an identifier of the first operation and the first message together in the shortcut message list; or setting, in the shortcut message list, a display format of the first message to a target format configured for prompting that the first message is associated with the first operation.

The obtaining a first message associated with the first state may include but is not limited to: obtaining, according to a preset association relationship, one or more first messages associated with the first state, or generating one or more first messages according to the first state.

In an example, the displaying, in a shortcut message list, the first message corresponding to the first state includes at least one of the following: displaying the first message at a top location of the shortcut message list; or displaying the first message and N messages that are not associated with a state of the first virtual object in the shortcut message list, N being a positive integer greater than or equal to 2. In some examples, the first message and the N messages that are not associated with the state of the first virtual object are displayed according to different display formats.

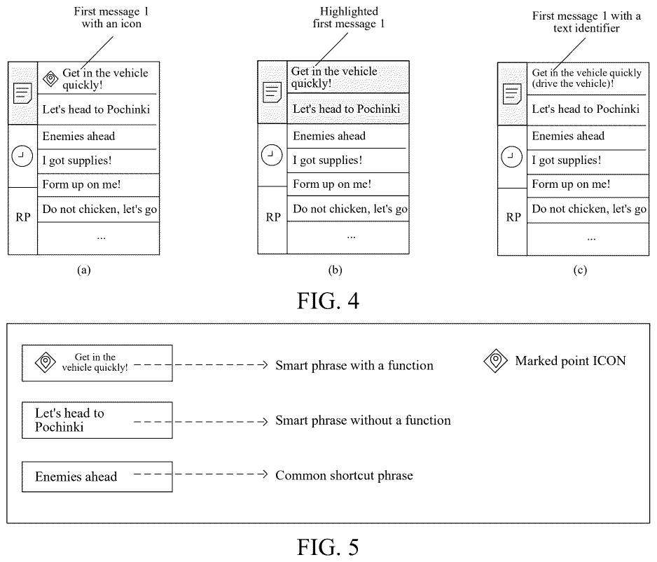

To help a player quickly find a first message that is currently required, a first message corresponding to a first state is displayed at a top of a shortcut message list shown in (a) in FIG. 4. Alternatively, to further distinguish between the first message and another shortcut message that is not associated with a state of the first virtual object, first messages “Get in the vehicle quickly” and “Let's head to Pochinki” may be displayed, in a highlighted form, at a top location of the shortcut message list shown in (b) in FIG. 4.

In addition, in an example of this application, messages in the shortcut message list include, but are not limited to, a first message intelligently displayed when a preset condition is met, and a shortcut message that is pre-configured by a player before a game starts and that is not associated with the state of the first virtual object. A quantity of shortcut messages pre-configured by the player and a display order of the N messages are fixed.

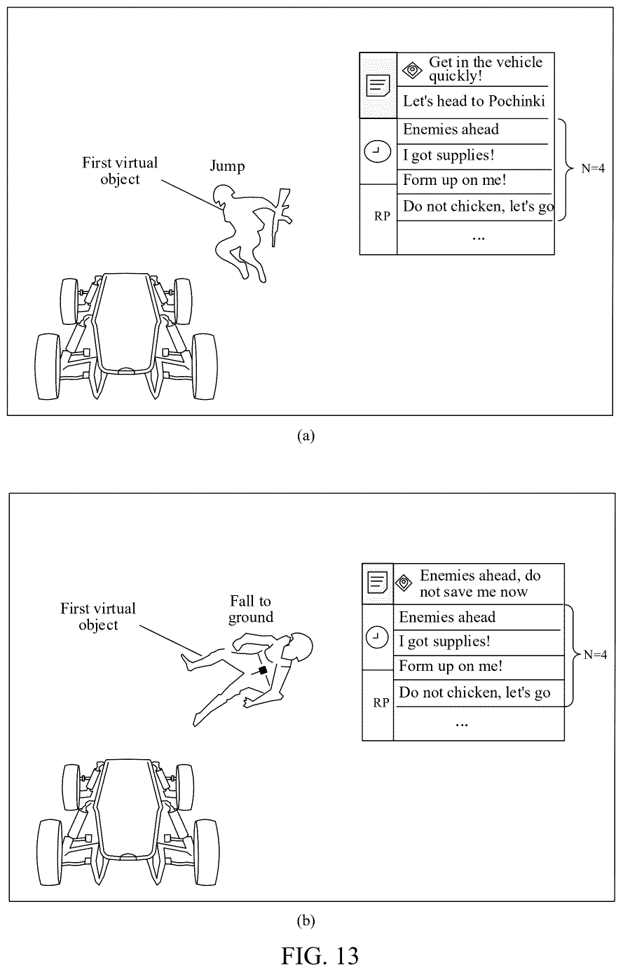

For example, as shown in FIG. 13, before a game starts, a player pre-configures four shortcut messages (N=4) that are not associated with the state of the first virtual object and that are shown in (a) in FIG. 13. When the first state of the first virtual object is a jumping state, the first trigger operation is performed, and first messages “Get in the vehicle quickly” and “Let's head to Pochinki” are displayed at the top location of the shortcut message list.

As shown in (b) in FIG. 13, when the first virtual object is in a falling-to-ground state, the first trigger operation is performed, and a first message “Enemies ahead, don't save me now” is displayed at the top location of the shortcut message list.

In an exemplary implementation, the displaying, in a shortcut message list, the first message corresponding to the first state includes: displaying the first message and the N messages in the shortcut message list, a display order of the N messages in the shortcut message list being fixed, and N being a positive integer greater than or equal to 2.

The method further includes: in a case that the first virtual object is not in the first state, displaying the shortcut message list on a game interface of a first game application in response to the first trigger operation, and displaying the N messages in the shortcut message list.

It can be intuitively learned from (a) and (b) in FIG. 13 that, no matter what condition is met, a first message that meets a corresponding condition is displayed at the top location of the shortcut message list, and four shortcut messages “Enemies ahead”, “I got supplies”, “Form up on me”, and “Do not chicken, let's go” are sequentially displayed below the first message, content of the four pre-configured shortcut messages is fixed, and an order of the four messages is also fixed.

In addition, a quantity of first messages is not limited. For example, the first message may include one message, or may include a plurality of messages. In addition, when the first message includes a plurality of messages, the plurality of messages may be messages bound to (or associated with) the first operation, and/or first messages not bound to the first operation. The following describes the first message bound to the first operation in detail with reference to a specific example.

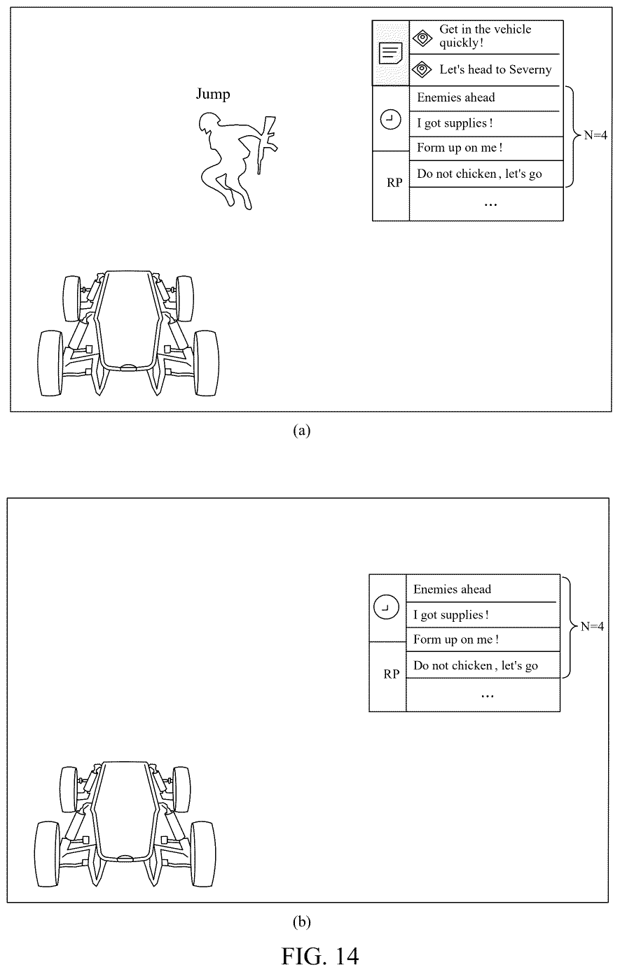

When the first virtual object is in the first state, the first trigger operation is performed, the shortcut message list may be displayed on the game interface, and the first message corresponding to the first state is displayed in the shortcut message list, which is specifically shown in (a) in FIG. 14. When the first virtual object is not in the first state, the first trigger operation is performed, the shortcut message list may also be displayed on the game interface, but only N shortcut messages pre-configured by the player are displayed in the shortcut message list. For details, reference may be made to (b) in FIG. 14.

In other words, when the first virtual object is not in the first state, display of the first message is canceled.

The first message may be intelligently recommended to the player according to a requirement by using the first message and the N shortcut messages pre-configured by the player that are included in the shortcut message list. Alternatively, one message may be selected, through a slide operation of the player, from the N shortcut messages as a message to be transmitted, thereby improving flexibility of selecting the first message by the player.

In another example, the displaying, in a shortcut message list, the first message corresponding to the first state includes: displaying the first message and the N messages in the shortcut message list in a case that the first virtual object is in the first state, a display order of the N messages in the shortcut message list being fixed, the first message including the first message, the first message corresponding to the first state, and N being a positive integer greater than or equal to 2.

As shown in (a) in FIG. 13, when the first state is a jumping state, the first trigger operation is performed, the shortcut message list is displayed on the game interface, and first messages “Get in the vehicle quickly” and “Let's head to Pochinki” corresponding to the jumping state are displayed at the top location of the shortcut message list.

As shown in (b) in FIG. 13, when the first state is a falling-to-ground state, the first trigger operation is performed, the shortcut message list is displayed on the game interface, and a first message “Enemies ahead, don't save me now” corresponding to the falling-to-ground state is displayed at the top location of the shortcut message list.

In other words, when a state of the first virtual object changes, the first trigger operation is performed, and different first messages are displayed in the shortcut message list on the game interface. The different first messages include, but are not limited to, different text content of the first messages, different quantities of first messages, and the like.

In the foregoing manner, different first messages corresponding to the first state may be displayed in the shortcut message list according to the first state of the first virtual object. Therefore, intelligent recommendation of shortcut messages is implemented, and in different scenarios, a suitable shortcut message may be used by a user.

In the related art, a function of a shortcut message is relatively single. For example, after the second trigger operation (tapping/clicking) is performed on a shortcut message, only text content (a vehicle ahead, get in the vehicle quickly, and the like) in the message may be transmitted. To increase diversity of the function of the shortcut message, a first action (the first operation) and the shortcut message that have a strong association relationship with each other may be bound together, so that the first operation may be performed when the shortcut message is transmitted. This process specifically includes: displaying an identifier of the first operation and the first message together in the shortcut message list; or setting, in the shortcut message list, a display format of the first message to a target format configured for prompting that the first message is associated with the first operation. For example, the target format is a highlight format.

In some examples, in a case that the first message is associated with the first operation, the first operation may be performed in response to the second trigger operation on the first message.

A first message to which the first operation is bound and a first message to which the first operation is not bound may be distinguished in, but not limited to, one of the following manners:

An ICON mark shown in (a) in FIG. 4 is added to the first message to which the first operation is bound.

The ICON mark shown in (a) in FIG. 4 is merely an example, which is not limited. For example, the ICON mark may alternatively be another customized icon, symbol, or the like.

A first message in a different display format is determined as the first message to which the first operation is bound. For example, as shown in (b) in FIG. 4, highlighted first messages “Get in the vehicle quickly” and “Let's head to Pochinki” are determined as the first messages to which the first operation is bound.

A first message carrying a text identifier is determined as the first message to which the first operation is bound, for example, “Get in the vehicle quickly (drive the vehicle)” shown in (c) in FIG. 4, and a first message “Let's head to Pochinki” without carrying the text identifier is the first message to which the first operation is not bound.

The text identifier “drive the vehicle” in “Get in the vehicle quickly (drive the vehicle)” shown in (c) in FIG. 4 is configured for representing an action strongly associated with the first state of the first virtual object. For example, when the first virtual object is close to a virtual vehicle and the first virtual object is in a jumping state, it means that the first virtual object is about to enter the virtual vehicle, and the purpose of entering the virtual vehicle is to drive the vehicle.

In addition, the first message to which the first operation is bound may alternatively be understood as a smart phrase with a function shown in FIG. 5, the first message to which the first operation is not bound may alternatively be understood as a smart phrase without a function shown in FIG. 5, and the shortcut message pre-configured by the player may alternatively be understood as a common shortcut message.

In an example, the displaying the first message on the game interface in response to the second trigger operation on the first message includes: in a case that the first message is bound to the first operation, transmitting the first message in response to the second trigger operation on the first message, and performing the first operation in the first game application, the first operation being an operation allowed by the first account to be performed.

For ease of understanding, the following provides descriptions by using an example of driving a virtual vehicle.

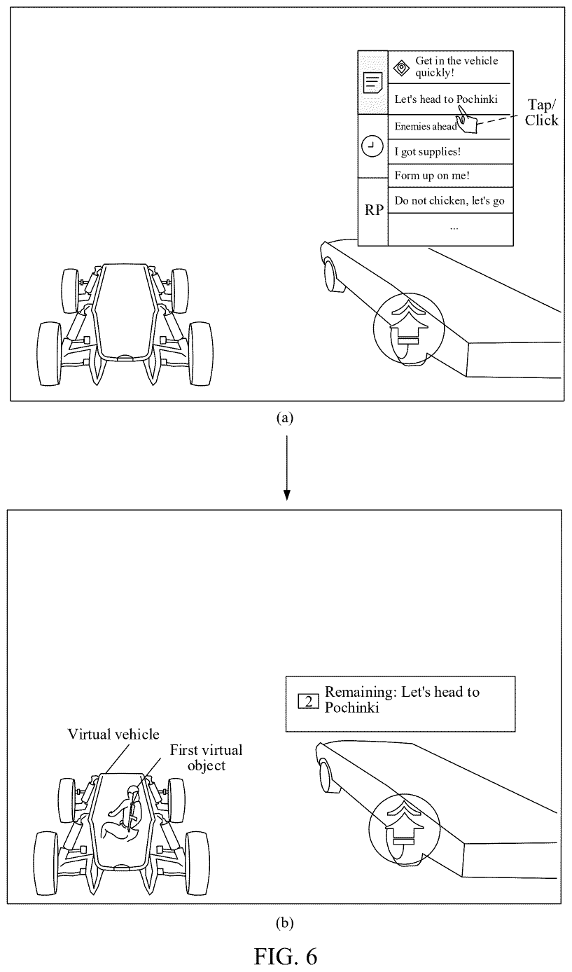

If the second trigger operation is a tapping/clicking operation. A first message “Let's head to Pochinki” shown in (a) in FIG. 6 is tapped/clicked, the text message “Let's head to Pochinki” is transmitted to a game interface shown in (b) in FIG. 6 (which may alternatively be understood as transmitting text information in a team), and a location of a virtual vehicle is marked (the first operation is performed).

The tapping/clicking operation is merely an example, which is not limited. For example, the second trigger operation may alternatively be a long-press operation, a drag operation, a double-tapping/clicking operation, or the like.

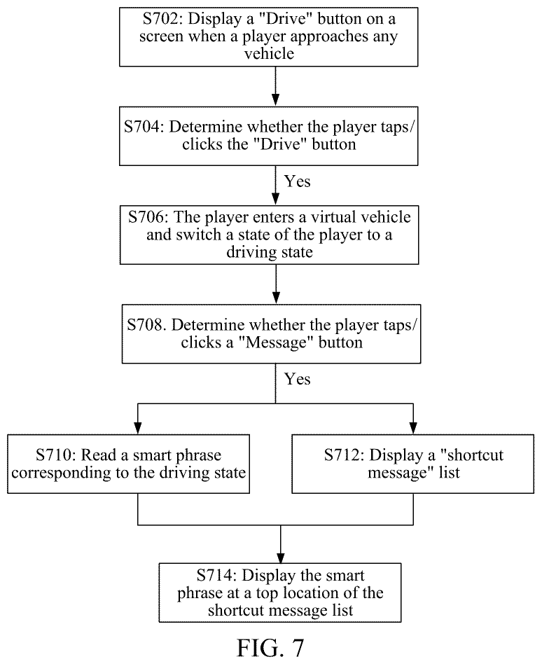

In a specific example, assuming that the first message to which the first operation is bound is a driving state, an implementation process thereof is shown as a flowchart in FIG. 7, and includes the following operations.
S702: Display a “Drive” button on a screen when a player approaches any vehicle.
S704: Determine whether the player taps/clicks the “Drive” button.
If the “Drive” button is tapped/clicked, operation S706 is performed.
S706: The player enters a virtual vehicle, and switch a state of the player to a driving state.
S708: Determine whether the player taps/clicks a “Message” button.

If the player taps/clicks the “Message” button, operation S710 and operation S712 are performed. For a style of the message button, reference may be made to interface diagrams shown in FIG. 3.

Because it is stipulated, according to preset logic, that a first virtual object controlled by the player is in a first state in a case that the player enters the virtual vehicle, after the first trigger operation is performed, a shortcut message list is displayed on a game interface, and a first message corresponding to the first state is displayed in the shortcut message list. Details are described in operations S710 to S714.
S710: Display the shortcut message list on the game interface.
S712: Display two first messages in the shortcut message list.

For example, “Get in the vehicle quickly” and “Let's head to Pochinki” are displayed.
S714: Display the two first messages at the top location of a shortcut phrase list (the shortcut message list).

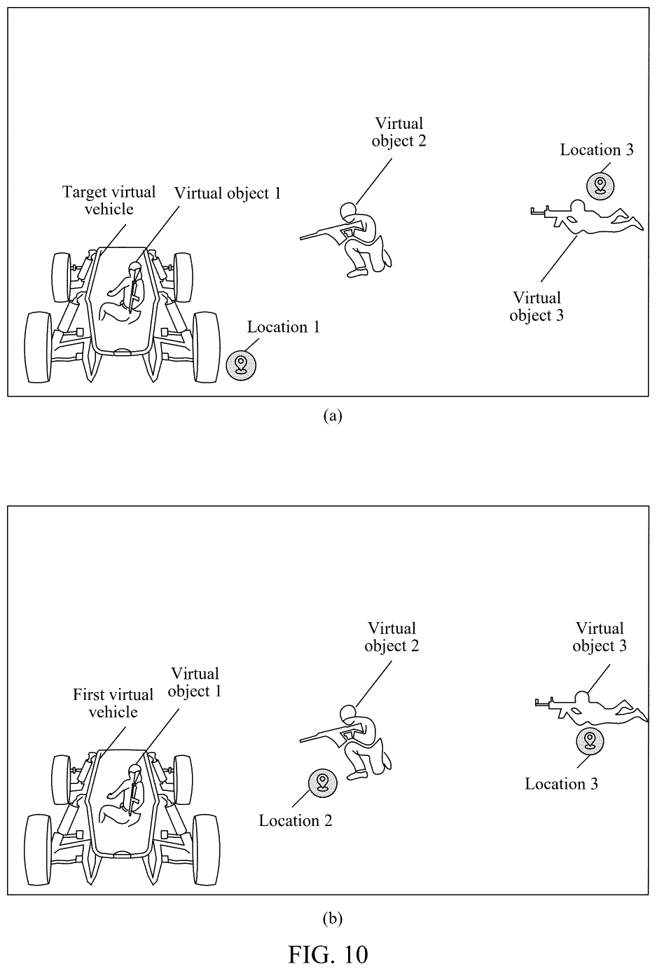

As shown in (a) in FIG. 6, because the first message “Get in the vehicle quickly” is a message to which the first operation is bound, and the first message “Let's head to Pochinki” is a message to which the first operation is not bound, after “Let's head to Pochinki” is tapped/clicked, only the text message “Let's head to Pochinki” is transmitted to a team (on the game interface). However, if a smart phrase “Get in the vehicle quickly” is tapped/clicked, when the text message “Get in the vehicle quickly” is transmitted to the team, a location of the virtual vehicle is marked. For details, reference may be made to a mark of a location 1 shown in (a) in FIG. 10.

In other words, when there are a plurality of first messages, the second trigger operation of the same type is performed on first messages of different types, and different actions may be performed according to a preset logic processing procedure. The first messages of different types include, but are not limited to, the first message to which the first operation is bound and the first message to which the first operation is not bound.

In another example, transmitting the first message in response to the second trigger operation of a second type on the first message, and performing the first operation includes:
displaying a long-press progress bar in response to the second trigger operation representing a long-press operation on the first message, the long-press progress bar being configured to represent duration of the long-press operation, and the long-press operation being, for example, an operation with a press time exceeding 0.1 s; and in a case that the long-press progress bar has reached a preset progress threshold, transmitting the first message, and performing the first operation; or
displaying duration of a long-press operation in response to the second trigger operation representing the long-press operation on the first message; and in a case that the duration of the long-press operation has reached a preset duration threshold, transmitting the first message, and performing the first operation.

For example, in a case that the first virtual object is in the first state, the shortcut message list is displayed on the game interface in response to the first trigger operation, for example, a message button shown in FIG. 3 is tapped/clicked, and the first message corresponding to the first state is displayed in the shortcut message list. Then, second trigger operations of different types are performed on the first message, so that different operations may be performed.

In some examples, in a case that the first message is associated with the first operation, the first operation may be performed in response to the second trigger operation on the first message.

In some examples, the transmitting the first message in response to a second trigger operation on the first message includes: transmitting the first message in response to the second trigger operation of a first type on the first message; and transmitting the first message in response to the second trigger operation of a second type on the first message, and performing the first operation, the second trigger operation of the first type being different from the second trigger operation of the second type.

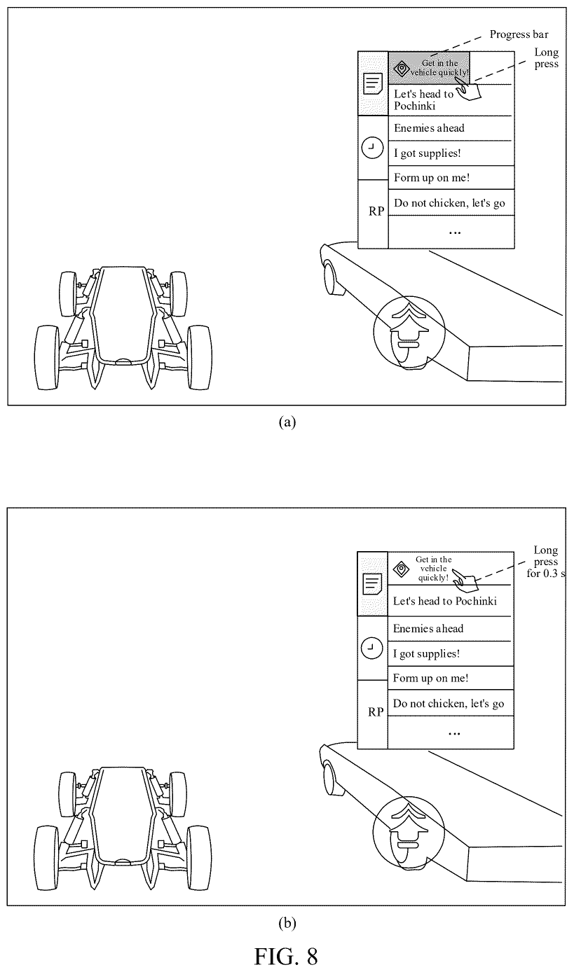

Specifically, when the second trigger operation of the first type is tapping/clicking, and the second trigger operation of the second type is long pressing, if a smart phrase “Get in the vehicle quickly” shown in (a) in FIG. 8 is tapped/clicked, the text message “Get in the vehicle quickly” is displayed on the game interface. A first operation of driving the virtual vehicle is bound to the smart phrase “Get in the vehicle quickly”.

If the smart phrase “Get in the vehicle quickly” shown in (a) in FIG. 8 is long pressed, the text message “Get in the vehicle quickly” is displayed on the game interface, and a corresponding first action (first operation) is also performed in a case that a preset condition is met.

In an example, the transmitting the first message in response to the second trigger operation of a second type on the first message, and performing the first operation includes: displaying a long-press progress bar in response to the second trigger operation representing a long-press operation on the first message, the long-press progress bar being configured to represent duration of the long-press operation; and in a case that the long-press progress bar has reached a preset progress threshold, transmitting the first message, and performing the first operation; or displaying duration of a long-press operation in response to the second trigger operation representing the long-press operation on the first message; and in a case that the duration of the long-press operation has reached a preset duration threshold, transmitting a first message, and performing the first operation.

For example, assuming that the smart phrase “Get in the vehicle quickly” shown in (a) in FIG. 8 is long pressed, a long-press progress bar is displayed, and when one of the following conditions is met, the text message “Get in the vehicle quickly” is displayed on the game interface, and the first operation is performed. A type of the first operation includes, but is not limited to, the following two cases:

First case: When the long-press progress bar has reached a preset progress threshold, for example, has reached 100%, the first message “Get in the vehicle quickly” may be displayed on the game interface, and the first virtual object enters a virtual vehicle and performs a driving operation.

Second case: As shown in (b) in FIG. 8, in a case that duration of the long-press operation has reached a preset duration threshold, for example, the duration has reached 0.3 s or more, the first message “Get in the vehicle quickly” is displayed on the game interface, and the first virtual object enters a virtual vehicle and performs a driving operation.

In the foregoing manner, a function and the first message that are strongly associated with each other are bound together, and in a case that the player performs one operation (tapping/clicking or long pressing) on the first message, a plurality of actions may be completed, for example, transmitting a text message of the first message to a team on the game interface and performing a pre-bound first action, thereby simplifying an operation of the player and improving message processing efficiency.

In an example, the performing the first operation in the first game application includes at least one of the following: transmitting target content to a second account of a second virtual object that is in the same group as the first virtual object, the target content being content that is preset or that is generated according to a state of the first virtual object; performing a marking operation on a location of the first virtual object; performing a marking operation on a location of a third virtual object that attacks the first virtual object; performing a marking operation on a location of a third virtual object that is in a different group from the first virtual object; or performing a marking operation on a location of a third virtual object that is in a different group from the first virtual object, in a case that it is determined that a distance between the third virtual object that is in the different group from the first virtual object and the first virtual object is less than or equal to a distance threshold. Herein, the distance threshold may be limited according to an application scenario, and is for example, 400 m.

For example, as shown in (a) in FIG. 10, if a virtual object 1 to a virtual object 3 are in the same group and the virtual object 1 is the first virtual object. In response to the second trigger operation performed on the first message, the first message is displayed on the game interface, and the first message is transmitted to the virtual object 2 and the virtual object 3.

For another example, in a case that the virtual object 1 is the first virtual object, in response to the second trigger operation performed on the first message, the first message is displayed on the game interface, and a marking operation is performed on a location of the virtual object 1. for example, the location of the virtual object 1 is marked as a location 1.

For another example, as shown in (b) in FIG. 10, if the virtual object 2 and the virtual object 3 attack the virtual object 1. In a case that the virtual object 1 is the first virtual object, in response to the second trigger operation performed on the first message, the first message is displayed on the game interface, and locations of the virtual object 2 and the virtual object 3 that attack the first virtual object are marked, for example, the location of the virtual object 2 is marked as a location 2, and the location of the virtual object 3 is marked as a location 3.

For another example, a marking operation or the like is performed on a location of a virtual object that is in a different group from the first virtual object in a case that a distance between the virtual object that is in the different group from the first virtual object and the first virtual object is less than a preset distance threshold.

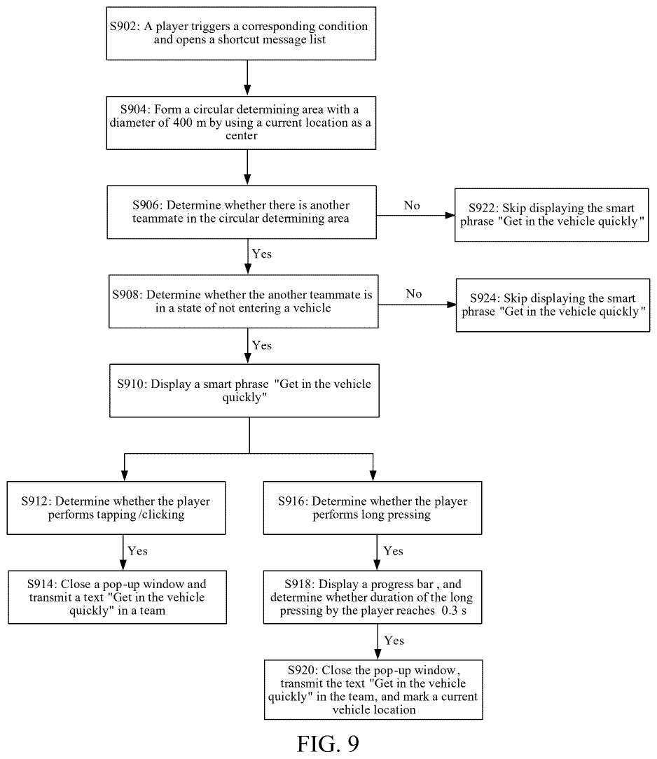

To more clearly understand an implementation process of performing the first operation in the first game application, the following provides further descriptions with reference to an example shown in FIG. 9.
S902: A player triggers a corresponding condition, and opens a shortcut message list.

For example, when a first virtual object controlled by the player is in a jumping state, the shortcut message list is displayed on the game interface in response to a first trigger operation performed on the message button shown in FIG. 3.
S904: Form a circular determining area with a diameter of 400 meters by using a current location as a center.

For example, a circular area having a diameter of 400 meters is formed by using a coordinate location of a first virtual vehicle in which the first virtual object is riding as a center point of a circle.
S906: Determine whether there is another teammate in the circular determining area.

If there is another teammate, operation S908 is performed; or if there is no other teammate, operation S922 is performed.
S908: Determine whether the another teammate is in a state of not entering the first virtual vehicle.

If the another teammate is in the state of not entering the first virtual vehicle, operation S910 is performed; or if the another teammate is not in the state of not entering the first virtual vehicle, operation S924 is performed.
S910: Display a smart phrase “Get in the vehicle quickly” at a top of the shortcut message list.

It can be learned with reference to the foregoing examples that, after the smart phrase “Get in the vehicle quickly” is displayed at the top of the shortcut message list, second trigger operations of different types may be performed on the smart phrase, and different first operations may be performed in the first game application. For details, reference is made to operations S912 to S920.
S912: Determine whether the player performs a long-press operation on the smart phrase “Get in the vehicle quickly”.

If the player performs the long-press operation on the smart phrase “Get in the vehicle quickly”, operation S918 is performed.
S914: Close a pop-up window (the shortcut message list) and transmit the text message “Get in the vehicle quickly” in a team.
S916: Determine, in real time, whether the player performs the long-press operation on the smart phrase “Get in the vehicle quickly”.
S918: Display a progress bar, and determine whether duration in which the player performs long pressing reaches 0.3 s.

0.3 s may be, but is not limited to, a preset duration threshold. 0.3 s is merely an example, which is not limited.

If the duration of the long-press operation reaches the preset duration threshold of 0.3 s, operation S920 is performed.
S920: Close the pop-up window (the shortcut message list), transmit the text message “Get in the vehicle quickly” to the team, and perform a first operation.

The first operation may be, but is not limited to, marking a current location of a first virtual vehicle. For details, reference may be made to (a) in FIG. 10. Alternatively, a current location of a first virtual vehicle is marked and the marked location is synchronized to another teammate.

It can be learned that the long-press operation is performed on the smart phrase “Get in the vehicle quickly”, and different first operations may be performed in a case that a preset condition is met.
S922: Skip displaying the smart phrase “Get in the vehicle quickly”.
S924: Skip displaying the smart phrase “Get in the vehicle quickly”.

In the foregoing manner, the first message may be displayed according to a preset condition in a case that the condition is met, one operation is performed on the first message, and a plurality of operations bound to the preset condition may be performed, thereby reducing operations of the player, and improving shortcut message processing efficiency.

In an example, the transmitting target content to a second account of a second virtual object that is in the same group as the first virtual object includes at least one of the following:
transmitting, in a case that the first virtual object is located in a first virtual vehicle that is allowed to move, the target content indicating a location of the first virtual vehicle to the second account of the second virtual object that is in the same group as the first virtual object;
transmitting, in a case that the first virtual object marks a target location in an electronic map of the virtual scene, the target content indicating the target location to the second account of the second virtual object that is in the same group as the first virtual object, the electronic map being, for example, a game map of a game application;
transmitting, in a case that the first virtual object marks a target location in an electronic map of the virtual scene, and the target location is in a preset target area in the electronic map, the target content indicating an area identifier of the target area to the second account of the second virtual object that is in the same group as the first virtual object, the target area being, for example, an area that is designated in advance in the electronic map, which is not limited in this application; or
transmitting, in a case that a distance between a third virtual object that is in a different group from the first virtual object and the first virtual object is less than or equal to a distance threshold, the target content indicating a location of the third virtual object that is in the different group from the first virtual object to the second account of the second virtual object that is in the same group as the first virtual object.

As shown in (b) in FIG. 10, it is assumed that the virtual object 1 is located in a first virtual vehicle that is allowed to move. The first message is displayed on the game interface in response to the second trigger operation performed on the first message, a marking operation is performed on a location of the first virtual vehicle, and then the marked location of the first virtual vehicle is transmitted to a virtual object that is in the same group as the virtual object 1.

It is assumed that the first virtual object marks a current location in the electronic map as a location 1. The first message is displayed on the game interface in response to the second trigger operation performed on the first message, and the location 1 is transmitted to a virtual object that is in the same group as the first virtual object.

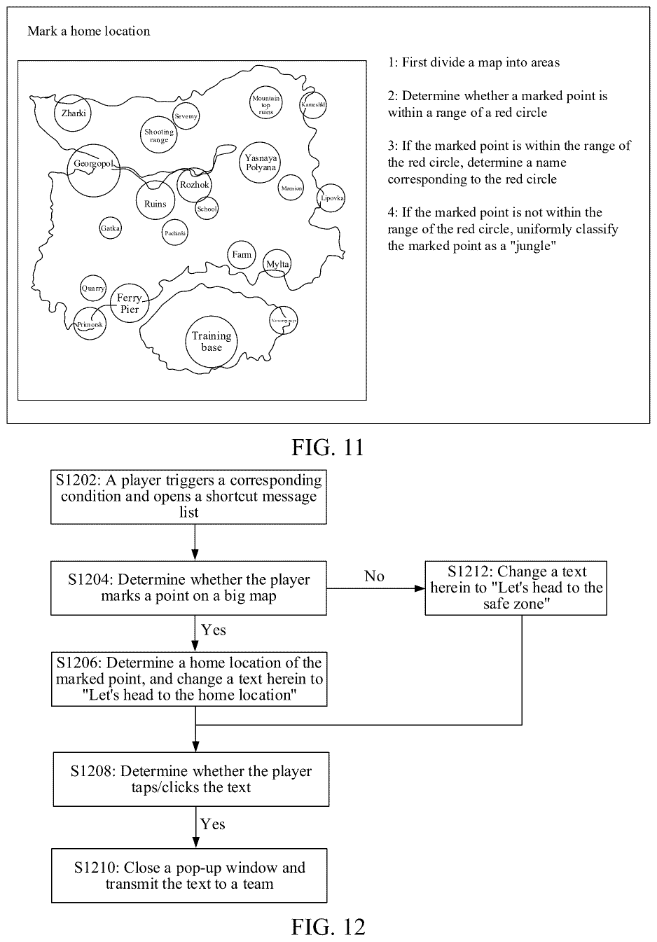

Also or alternatively, as shown in FIG. 11, if a player divides the electronic map into a plurality of areas, and each area corresponds to an area identifier. In a case that the first virtual object marks the current location in the electronic map as the location 1, and the location 1 is in a preset first area of Rozhok, an area identifier of Rozhok is transmitted to a virtual object that is in the same group as the first virtual object.

For another example, in a case that a distance between a virtual object that is in a different group from the first virtual object and the first virtual object is less than or equal to a preset distance threshold, a location of the virtual object that is in the different group from the first virtual object is transmitted to the second virtual object that is in the same group as the first virtual object.

In an example, the displaying, on an interaction interface, a shortcut message list including the first message includes:
detecting whether the second virtual object that is in the same group as the first virtual object exists within a first preset range; and displaying the first message in the shortcut message list in a case that it is determined that the second virtual object exists within the first preset range, when the first state indicates that the first virtual object is located in the first virtual vehicle that is allowed to move, the first message being configured for prompting that the first virtual object rides in the first virtual vehicle, the first preset range being, for example, a range centered on the first virtual object and having a radius of 10 m; or
detecting whether the third virtual object that is in the different group from the first virtual object exists within a second preset range, the second preset range being, for example, a range centered on the first virtual object and having a radius of 50 m; and displaying the first message in the shortcut message list in a case that it is determined that the third virtual object exists within the second preset range, when the first state indicates that the first virtual object is attacked by the third virtual object in the different group, the first message being configured for prompting that the third virtual object that is in the different group from the first virtual object appears, or the third virtual object is attacked; or
detecting whether the first virtual object marks the target location in the electronic map of the virtual scene; displaying the first message and an identifier of the target location together in the shortcut message list in a case that it is determined that the target location is marked; and displaying the first message and an identifier of a default area together in the shortcut message list in a case that it is determined that the target location is not marked; or
detecting whether the first virtual object marks the target location in the electronic map of the virtual scene; detecting whether the target location is in a preset target area in the electronic map in a case that it is determined that the target location is marked; displaying the first message and an identifier of the target location together in the shortcut message list in a case that the target location is in the preset target area in the electronic map; and displaying the first message and an identifier of a default area together in the shortcut message list in a case that it is determined that the target location is not marked, or the target location is not in the preset target area in the electronic map.

For example, assuming that the first virtual object is in a driving state and a teammate of the first virtual object is located within the first preset range, the message button shown in FIG. 3 is tapped/clicked, the shortcut message list is displayed on the game interface, and a first message “Do not chicken, let's go” is displayed at the top location of the shortcut message list.

In an example, displaying, in response to the first trigger operation in a case that the first virtual object is in the first state and a virtual object that is in the same group as the first virtual object is located within the first preset range, the shortcut message list on the game interface and displaying the first message corresponding to the first state in the shortcut message list includes:
displaying, in response to the first trigger operation in a case that the first virtual object is located in the first virtual vehicle that is allowed to move and the virtual object that is in the same group as the first virtual object is located within the first preset range, the shortcut message list on the game interface, and displaying the first message corresponding to the first virtual vehicle in the shortcut message list, the first preset range being a range determined by using a location of the first virtual vehicle as a center, and the first message being configured for prompting that the virtual object that is in the same group as the first virtual object rides in in the first virtual vehicle.

For another example, assuming that the first virtual object is in a driving state and a teammate of the first virtual object is located within the second preset range, the message button shown in FIG. 3 is tapped/clicked, the shortcut message list is displayed on the game interface, and a first message “I need rescue” is displayed at the top location of the shortcut message list.

In an example, displaying, in response to the first trigger operation in a case that the first virtual object is in the first state and a virtual object that is in a different group from the first virtual object is located within the second preset range, the shortcut message list on the game interface and displaying the first message corresponding to the first state in the shortcut message list includes:
displaying, in response to the first trigger operation in a case that the first virtual object is attacked by the virtual object that is in the different group from the first virtual object, and the virtual object that is in the different group from the first virtual object is located within the second preset range, the shortcut message list on the game interface, and displaying the first message in the shortcut message list, the first message being configured for prompting the virtual object that is in the same group as the first virtual object with the following information: The virtual object that is in the different group from the first virtual object appears, or the first virtual object is attacked.

For another example, assuming that the first virtual object marks a current location on the electronic map as a location 1, if the first virtual object is in a driving state, the message button shown in FIG. 3 is tapped/clicked, the shortcut message list is displayed on the game interface, and a first message “Quickly come to the location 1” is displayed at the top location of the shortcut message list.

For another example, assuming that the first virtual object marks a current location on the electronic map as a location 1, and the location 1 is in an area of Pochinki on the electronic map, if the first virtual object is in a driving state, the message button shown in FIG. 3 is tapped/clicked, the shortcut message list is displayed on the game interface, and a first message “Let's head to Pochinki” is displayed at the top location of the shortcut message list, “Let's head to” being a first message corresponding to the driving state and a first location of Pochinki.

For another example, assuming that the first virtual object marks a current location on the electronic map as a location 1, and the location 1 is located outside a plurality of pre-identified areas (for example, Zharki, Severny, and Georgopol shown in FIG. 11) in the electronic map, if the first virtual object is in a driving state, the message button shown in FIG. 3 is tapped/clicked, the shortcut message list is displayed on the game interface, and a first message “Let's head to the safe zone” is displayed at the top location of the shortcut message list, “Let's head to the safe zone” being the first message corresponding to the driving state and a preset default area.

In other words, when the first virtual object is in different first states, the first trigger operation is performed, and the shortcut message list may be displayed on the interaction interface. However, first messages that correspond to the different first states and that include different text content may be displayed at the top location of the shortcut message list, so that a player can find a suitable shortcut message to use in different scenarios, to improve convenience of transmitting a message.

To more clearly understand an implementation process of displaying the first messages, the implementation process is further described below with reference to a flowchart shown in FIG. 12.
S1202: A player triggers a corresponding condition, and opens a shortcut message list.
S1204: Determine whether the player performs marking on an electronic map.

The electronic map is divided in advance into a plurality of areas shown in FIG. 11 in advance, and the player may perform marking in the plurality of areas obtained through division or outside the plurality of areas obtained through division in a big map.

If the player performs marking on the electronic map, operation S1206 is performed. If the player does not perform marking on the electronic map, operation S1212 is performed.
S1206: Determine a home location of the marked point, and display a first message “Let's head to XX” in the shortcut message list.

For example, when a mark made by the player on the electronic map is located in an area of Rozhok, a first message “Let's head to Rozhok” is displayed in the shortcut message list. When the mark made by the player on the electronic map is located in an area of Gatka, a first message “Let's head to Gatka” is displayed in the shortcut message list.

When the mark made by the player on the electronic map is located outside the plurality of areas shown in FIG. 11, operation S1212 is performed.
S1208: Determine whether the player taps/clicks the first message.

If the first message is tapped/clicked, operation S1210 is performed.
S1210: Close a pop-up window (the shortcut message list), and transmit a text message to a team.

For example, the text message “Let's head to Rozhok” or “Let's head to Gatka” is transmitted to the team.
S1212: Switch content of the first message to “Let's head to the safe zone”.

It can be learned with reference to analysis of the foregoing examples that, when a state of a first virtual object is a first state, a first message corresponding to the first state may be displayed at a top location of a shortcut message list by using a simple trigger operation and by using a preset logical condition, so that a requirement of a player for a shortcut message in any scenario is met, and a complex process of finding a first message through a continuous slide operation is avoided, thereby reducing operation time, and improving message processing efficiency.

In addition, an action and a text message that are strongly associated are bound, the player may transmit pure text content by using two touch operations of different types, namely, tapping/clicking or long pressing, or perform a bound first operation when the text content is transmitted. An operation that requires at least four to five steps before may be completed through a simple long-press operation without changing an operation habit of the player, ensuring convenience of a user operation and convenience of transmitting a message, thereby improving efficiency of communication between users.

For brief description, the foregoing method examples are represented as a series of action combinations. However, a person skilled in the art are to appreciate that this application is not limited to the described order of the actions, because according to this application, some operations may be performed in other orders or simultaneously. In addition, a person skilled in the art are also to know that all examples described in the specification are preferred examples, and the related actions and modules are not necessarily required to this application.

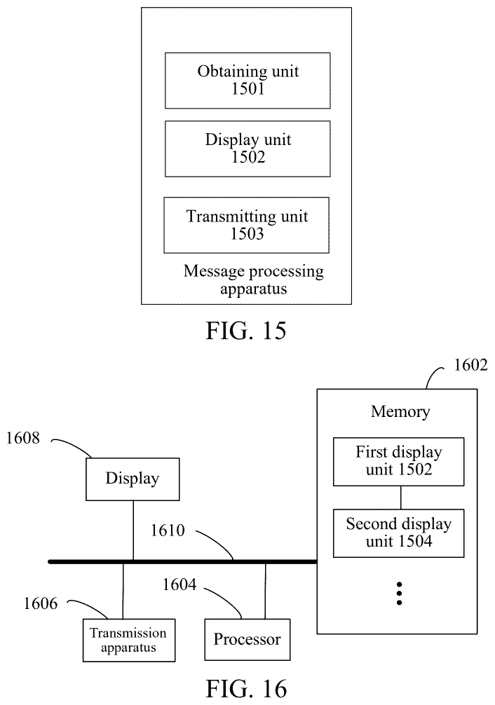

According to another aspect of the examples of this application, a message processing apparatus shown in FIG. 15 is further provided. The apparatus includes: an obtaining unit 1501, configured to obtain, in response to a first trigger operation in a case that a first virtual object is a first state, a first message associated with the current first state of the first virtual object, the first state indicating a first behavior of the first virtual object in a virtual scene; a display unit 1502, configured to display, on an interaction interface, a shortcut message list including the first message; and a transmitting unit 1503, configured to transmit the first message in response to a second trigger operation on the first message.

According to the foregoing apparatus provided in this application, in a case that the first virtual object is in the first state, the first message corresponding to the first state may be displayed in the shortcut message list on the interaction interface through the first trigger operation, and the corresponding first message may be transmitted through the second trigger operation. In other words, the first message meeting a scenario requirement (that is, associated with the first state) may be displayed on the interaction interface through a simple touch operation, to avoid trouble of editing a message or finding a message through a slide operation by a user, and facilitate the user to transmit an expected message, so as to improve message transmitting efficiency and operation convenience. For example, in a game scenario, the foregoing solution not only meets communication requirements of players in different game scenarios, but also reduces a large quantity of operation processes, thereby achieving a technical effect of improving message processing efficiency.

For the example of the message processing apparatus herein, reference may be made to the examples of the foregoing message processing method, and details are not described herein again.

According to still another aspect of the examples of this application, an electronic device configured to implement the foregoing message processing method is further provided. The electronic device may be a terminal device shown in FIG. 16. This example is described by using an example in which the electronic device is a background device. As shown in FIG. 16, the electronic device includes a memory 1602 and a processor 1604. The memory 1602 stores a computer program, and the processor 1604 is configured to perform operations in any one of the foregoing method examples by using the computer program.

In this example, the electronic device may be located in at least one of a plurality of network devices in a computer network.

In this example, the processor may be configured to perform the message processing method by using the computer program.

In some examples, a person skilled in the art may understand that the structure shown in FIG. 16 is merely an example. The electronic device may alternatively be a target terminal such as a smartphone (for example, an Android mobile phone or an iOS mobile phone), a tablet computer, a palmtop computer, a mobile Internet device (MID), or a PAD. FIG. 16 does not limit a structure of the electronic device. For example, the electronic device may further include more or fewer components (for example, a network interface) than those shown in FIG. 16, or have a configuration different from that shown in FIG. 16.

The memory 1602 may be configured to store a software program and a module, for example, program instructions/a module corresponding to the message processing method and apparatus in this application. The processor 1604 runs the software program and the module stored in the memory 1602, to execute various functional applications and data processing, that is, implement the foregoing message processing method. The memory 1602 may include a high-speed random memory, and may also include a non-volatile memory, for example, one or more magnetic storage apparatuses, a flash memory, or another non-volatile solid-state memory. In some examples, the memory 1602 may further include memories remotely disposed relative to the processor 1604, and these remote memories may be connected to a terminal via a network. Examples of the network include, but are not limited to, the Internet, an enterprise intranet, a local area network, a mobile communication network, and a combination thereof. The memory 1602 may be specifically configured to, but is not limited to, store a first trigger operation, a shortcut message list, and a target state. In an example, as shown in FIG. 16, the memory 1602 may include, but is not limited to, a first display unit 1502 and a second display unit 1504 in the message processing apparatus. In addition, the memory 1602 may further include, but is not limited to, another module unit in the foregoing message processing apparatus. Details are not described in this example again.

In some examples, a transmission apparatus 1606 is configured to receive or transmit data via network. A specific example of the network may include a wired network or a wireless network. In an example, the transmission apparatus 1606 includes a network interface card (NIC), which may be connected to another network device and a router via a data cable, to communicate with the Internet or a local area network. In an example, the transmission apparatus 1606 is a radio frequency (RF) module, and is configured to communicate with the Internet in a wireless manner.

In addition, the electronic device may further include: a display 1608, configured to display orientation prompt information of a target sound; and a connection bus 1616, configured to connect each module component of the electronic device.

In another example, the target terminal or the server may be a node in a distributed system. The distributed system may be a blockchain system, and the blockchain system may be a distributed system formed by connecting a plurality of nodes in a network communication form. A peer-to-peer (P2P) network may be formed among the nodes. A computing device in any form, for example, an electronic device such as a server or a terminal, may become a node in the blockchain system by joining the P2P network.

According to still another aspect of this application, a computer program product or a computer program is provided, the computer program product or the computer program including computer instructions, and the computer instructions being stored in a computer-readable storage medium. A processor of a computer device reads the computer instructions from the computer-readable storage medium, and the processor executes the computer instructions, so that the computer device performs the message processing method provided in various exemplary implementations in the foregoing aspects such as server verification processing. The computer program, when being run, is configured to perform the operations in any one of the foregoing method examples.

In this example, the computer-readable storage medium may be configured to store a computer program configured to perform the foregoing message processing method.

In this example, a person skilled in the art may understand that all or some of the operations of the methods in the foregoing examples may be implemented by a program instructing relevant hardware of the target terminal. The program may be stored in the computer-readable storage medium, and the storage medium may include: a flash drive, a read-only memory (ROM), a random access memory (RAM), a magnetic disk, an optical disc, and the like.

The sequence numbers of the foregoing examples of this application are merely for description but do not represent the preference of the examples.

If the integrated units in the foregoing examples are implemented in a form of software functional units and are sold or used as independent products, the units may be stored in the computer-readable storage medium. Based on such an understanding, the technical solutions of this application essentially, or the part contributing to the prior art of the technical solutions, or all or some of the technical solutions may be implemented in a form of a software product. The computer software product is stored in a storage medium and includes several instructions, configured for causing one or more computer devices (which may be a personal computer, a server, a network device, or the like) to perform all or some of the operations of the methods in the examples of this application.

In the foregoing examples of this application, the description of each example has respective focuses. For a part that is not described in detail in an example, reference may be made to related descriptions of other examples.

In several examples provided in this application, the disclosed client may be implemented in another manner. For example, the apparatus example described above is merely exemplary. For example, the unit division is merely logical function division and may be division in another manner in actual implementation. For example, a plurality of units or components may be combined or integrated into another system, or some features may be ignored or not performed. In addition, the displayed or discussed mutual coupling or direct coupling or communication connection may be indirect coupling or communication connection implemented through some interfaces, units, or modules, and may be implemented in an electrical or another form.

The units described as separate components may or may not be physically separate, and the parts displayed as units may or may not be physical units, that is, may be located in one place, or may be distributed on a plurality of network units. Some or all of the units may be selected according to an actual need to achieve the objectives of the example solutions.

In addition, functional units in the examples of this application may be integrated into one processing unit, or each of the units may exist alone physically, or two or more units may be integrated into one unit. The foregoing integrated unit may be implemented in a form of hardware, or may be implemented in a form of a software functional unit.

The above are merely preferred examples of this application, and a person of skilled in the art may make several improvements and refinements without departing from the principle of this application. All such modifications and refinements are also to be considered as the protection scope this application.

In the examples of this application, the term “module” or “unit” refers to a computer program having a predetermined function or a part of a computer program, and works together with other relevant parts to achieve a predetermined objective, and may be entirely or partially implemented by using software, hardware (such as a processing circuit or a memory), or a combination thereof. Similarly, one processor (or a plurality of processors or memories) may be configured to implement one or more modules or units. In addition, each module or unit may be a part of an entire module or unit including a function of the module or unit.

What is claimed is:

1. A method comprising:
obtaining, by a computing device, in response to a first trigger operation when a first virtual object is in a state, a message associated with the state, the state indicating a first behavior of the first virtual object in a virtual scene;
displaying, on an interaction interface, a shortcut message list comprising the message; and
transmitting the message in response to a second trigger operation on the message.

2. The method according to claim 1, wherein the first virtual object is a virtual character associated with a first account configured for logging in to the virtual scene; and
the transmitting the message comprises: transmitting, in response to the second trigger operation on the message, the message to a second account of one or more second virtual objects associated with the first virtual object.

3. The method according to claim 1, wherein the message is associated with a first operation, and the method further comprises:
displaying an identifier of the first operation and the message together in the shortcut message list; and
setting, in the shortcut message list, a display format of the message to a target format configured for prompting that the message is associated with the first operation.

4. The method according to claim 3, further comprising:
performing the first operation in response to the second trigger operation on the message.

5. The method according to claim 3, wherein the message is associated with the first operation, and the transmitting the message comprises:
transmitting the message in response to the second trigger operation of a first type on the message; and
transmitting the message in response to the second trigger operation of a second type on the message, and performing the first operation, the second trigger operation of the first type being different from the second trigger operation of a second type.

6. The method according to claim 5, wherein the transmitting the message in response to the second trigger operation of the second type on the message, and performing the first operation comprises:
displaying a long-press progress bar in response to the second trigger operation, the long-press progress bar indicating a duration of a long-press operation; and based on that the long-press progress bar has reached a preset progress threshold, transmitting the message, and performing the first operation; or
displaying a duration of the long-press operation in response to the second trigger operation that represents the long-press operation on the message; and based on that the duration of the long-press operation has reached a preset duration threshold, transmitting the message, and performing the first operation.

7. The method according to claim 4, wherein the performing the first operation comprises at least one of the following:
transmitting target content to a second account of a second virtual object that is in the same group as the first virtual object;
performing a marking operation on a location of the first virtual object;
performing a marking operation on a location of a third virtual object that attacks the first virtual object;
performing a marking operation on a location of a third virtual object that is in a same group as the first virtual object; or
performing a marking operation on a location of a third virtual object that is in a different group from the first virtual object.

8. The method according to claim 7, wherein the transmitting target content to the second account of the second virtual object that is in the same group as the first virtual object comprises at least one of the following:
transmitting, based on that the first virtual object is located in a first virtual vehicle that is allowed to move, the target content indicating a location of the first virtual vehicle to the second account;
transmitting, based on that the first virtual object marks a target location in an electronic map of the virtual scene, the target content indicating the target location to the second account;
transmitting, based on that the first virtual object marks a target location in an electronic map of the virtual scene, and the target location is in a preset target area in the electronic map, the target content indicating an area identifier of the target area to the second account; or
transmitting, based on that a distance between the third virtual object that is in the different group from the first virtual object and the first virtual object is less than or equal to a distance threshold, the target content indicating the location of the third virtual object to the second account.

9. The method according to claim 1, wherein the displaying, on the interaction interface, the shortcut message list comprising the message comprises:
determining whether a second virtual object that is in the same group as the first virtual object exists within a first preset range; and
displaying the message in the shortcut message list based on determining that the second virtual object exists within the first preset range, wherein the state indicates that the first virtual object is located in a virtual vehicle that is allowed to move, and the message indicates that the first virtual object rides in the virtual vehicle.

10. The method according to claim 1, wherein the displaying, on the interaction interface, the shortcut message list comprising the message comprises:
determining whether a third virtual object that is in a different group from the first virtual object exists within a second preset range; and displaying the message in the shortcut message list based on determining that the third virtual object exists within the second preset range, wherein the state indicates that the first virtual object is attacked by the third virtual object in the different group, and the message indicates that the third virtual object appears, or the third virtual object is attacked.

11. The method according to claim 1, wherein the displaying, on the interaction interface, the shortcut message list comprising the message comprises:
determining whether the first virtual object marks a target location in an electronic map of the virtual scene; displaying the message and an identifier of the target location in the shortcut message list based on determining that the target location is marked; and displaying the message and an identifier of a default area in the shortcut message list based on determining that the target location is not marked; or
determining whether the first virtual object marks the target location in the electronic map of the virtual scene; determining whether the target location is in a preset target area in the electronic map based on determining that the target location is marked; displaying the message and the identifier of the target location together in the shortcut message list based on that the target location is in the preset target area in the electronic map; and displaying the message and the identifier of the default area in the shortcut message list based on determining that the target location is not marked, or the target location is not in the preset target area in the electronic map.

12. The method according to claim 1, wherein the displaying, on the interaction interface, the shortcut message list comprising the message comprises:
displaying the message at a top location of the shortcut message list; and
displaying the message and a plurality of additional messages that are not associated with a state of the first virtual object in the shortcut message list.

13. The method according to claim 1, further comprising: based on that the message associated with the state is not obtained, displaying a plurality of messages that are not associated with the state of the first virtual object in the shortcut message list.

14. An apparatus, comprising:
one or more processors; and
memory storing instructions that, when executed by the one or more processors, cause the apparatus to:
obtain in response to a first trigger operation when a first virtual object is in a state, a message associated with the state, the state indicating a first behavior of the first virtual object in a virtual scene;
display, on an interaction interface, a shortcut message list comprising the message; and
transmit the message in response to a second trigger operation on the message.

15. The apparatus according to claim 14, wherein the first virtual object is a virtual character associated with a first account configured for logging in to the virtual scene; and
the instructions, when executed by the one or more processors, cause the apparatus to transmit the message by transmitting, in response to the second trigger operation on the message, the message to a second account of one or more second virtual objects associated with the first virtual object.

16. The apparatus according to claim 14, wherein the message is associated with a first operation, and the instructions, when executed by the one or more processors, cause the apparatus to:
display an identifier of the first operation and the message together in the shortcut message list; and
set, in the shortcut message list, a display format of the message to a target format configured for prompting that the message is associated with the first operation.

17. The apparatus according to claim 16, wherein the instructions, when executed by the one or more processors, cause the apparatus to:
perform the first operation in response to the second trigger operation on the message.

18. The apparatus according to claim 14, wherein the message is associated with a first operation, and the instructions, when executed by the one or more processors, cause the apparatus to transmit the message by:
transmitting the message in response to the second trigger operation of a first type on the message; and
transmitting the message in response to the second trigger operation of a second type on the message, and performing the first operation, the second trigger operation of the first type being different from the second trigger operation of a second type.

19. The apparatus according to claim 14, wherein the instructions, when executed by the one or more processors, cause the apparatus to display, on the interaction interface, the shortcut message list comprising the message by:
displaying the message at a top location of the shortcut message list; and
displaying the message and a plurality of additional messages that are not associated with a state of the first virtual object in the shortcut message list.

20. A non-transitory computer-readable storage medium storing instructions that, when executed, cause:
obtaining, in response to a first trigger operation when a first virtual object is in a state, a message associated with the state, the state indicating a first behavior of the first virtual object in a virtual scene;
displaying, on an interaction interface, a shortcut message list comprising the message; and
transmitting the message in response to a second trigger operation on the message.
